(19) United States
(12) Patent Application Publication
(10) Pub. No.: US 2014/0180503 A1
(43) Pub. Date: Jun. 26, 2014

(54) SYSTEM FOR PROVIDING INDEPENDENT AND DISSIMILAR FLIGHT PARAMETER ESTIMATES OF AN AIRCRAFT AND ASSOCIATED AIRCRAFT

(71) Applicant: THALES, Neuilly Sur Seine (FR)

(72) Inventors: Florent COLLIAU, MEUDON LA FORET (FR); Cedric FLAVEN, MEUDON LA FORET (FR); Yves JAULAIN, MEUDON LA FORET (FR)

(73) Assignee: THALES, Neuilly Sur Seine (FR)

(21) Appl. No.: 14/102,708

(22) Filed: Dec. 11, 2013

(30) Foreign Application Priority Data
Dec. 11, 2012 (FR) 1203365

(51) Int. Cl. B64D 43/00

(52) U.S. Cl. CPC B64D 43/00
USPC 701/3

(57) ABSTRACT

The invention relates to a system for estimating flight parameters of an aircraft, having a plurality of static pressure ports and a plurality of measuring probes, each measuring probe having an aerial portion and an electronic device configured to estimate the flight parameters. A first and second measuring probe have identical aerial portions and identical electronic devices, a third measuring probe has an aerial portion and an electronic device that are different from those of the first measuring probe; the electronic devices of the first, second and third measuring probes and the static pressure ports are connected so as to form a first, second and a third data system respectively associated with a static pressure port, and each static pressure port of each of the data systems is separate from each static pressure port of the other data systems.

### CROSS-REFERENCE TO RELATED APPLICATIONS

This application claims priority to French Application No. 12 03365, filed on Dec. 11, 2012, which is incorporated herein by reference in its entirety.

### FIELD OF THE INVENTION

The present invention relates to systems for providing flight data of an aircraft.

More specifically, the invention relates to a system for estimating flight parameters of an aircraft, having

a plurality of static pressure ports;

a plurality of measuring probes, each measuring probe having an aerial portion capable of providing at least one physical quantity correlated to the flight parameters and different from the static pressure, an electronic device configured to estimate the flight parameters from the physical quantities, and at least one static pressure measurement.

### BACKGROUND

The invention is situated in the field of measuring systems responsible for acquiring and measuring local static and dynamic pressures and the local angle of attack of an aircraft, correcting the information due to the aerodynamic phenomena to which that aircraft is subjected, and computing the flight parameters from which the aircraft is piloted: altitude, angle of attack, the different airspeeds, etc.

For maintenance, weight and reliability reasons, these systems are increasingly based on the use of multifunctional electronic measuring probes, or MFEs, the aerial part of which protrudes from the skin of the aircraft and provides at least total pressure and angle of attack information. The aerial portion is coupled to the electronic device that is inside the aircraft, and that computes the different flight parameters in particular from the information delivered by the aerial portion, as well as one or more measurements of the static pressure and total temperature of the air.

The high security level in particular results in requirements in terms of independence relative to the parameters provided by the systems and dissimilarity of the elements they include.

Such a system is for example described in document U.S. Pat. No. 6,668,640 B1, which describes a system for providing flight parameter data according to two data channels. The parameters provided according to one of the data channels are independent from those provided by the other data channel, i.e., they are determined from distinct static pressure information sources. In order to avoid losing all of the data channels in case of any common-mode breakdown, the two data channels are different.

### SUMMARY

One aim of the invention is to propose an alternative architecture for this type of system for supplying flight parameters.

To that end, the invention relates to a system of the aforementioned type, in which:
a first measuring probe and a second measuring probe have identical aerial portions and identical electronic devices;
a third measuring probe has an aerial portion and an electronic device that are different from those of the first measuring probe and the second measuring probe;
the electronic devices of the first measuring probe, the second measuring probe and the third measuring probe, and the static pressure ports are connected so as to form a first data system, a second data system and a third data system respectively associated with at least one static pressure port and each providing a respective estimate of the same flight parameters,
the or each static pressure port of each of the first data system, the second data system and the third data system is different from the or each static pressure port of the others among the first data system, the second data system and the third data system.

According to other aspects of the invention, the system includes one or more of the following technical features, considered alone or according to any technically possible combination(s):
the electronic device of each measuring probe includes a first electronic channel and a second electronic channel, each of the first data system, the second data system and the third data system having a first channel of a measuring probe and a second channel of a measuring probe connected to each other;
the first data system includes the first channel of the first measuring probe and the second channel of the second measuring probe connected to each other, and the second data system includes the second channel of the first measuring probe and the first channel of the second measuring probe connected to each other;
the first data system includes a static pressure port on the aerial portion of the first measuring probe and a static pressure port positioned on the aerial portion of the second measuring probe, and the second data system includes a static pressure port positioned on the aerial portion of the second measuring probe and a static pressure port positioned on the aerial portion of the first measuring probe;
the first data system includes the first channel of the first measuring probe and the second channel of the first measuring probe, and the second data system includes the first channel of the second measuring probe and the second channel of the second measuring probe;
the system includes two primary static pressure probes separated from the measuring probes and situated on either side of the aircraft, the static pressure ports of the first data system being situated on one and the other of said primary static pressure probes and being connected to each other;
the system further includes two secondary static pressure probes separate from the measuring probes and situated on either side of the aircraft, the static pressure probes of the second data system being situated on one and the other of said secondary static pressure probes and being connected to each other;
the system includes two static pressure probes separated from the measuring probes and situated on either side of the aircraft, the static pressure probes of the third data system being situated on said static pressure probes and being connected to each other;
the third data system includes the first channel and the second channel of the third measuring probe;
the system further includes a fourth measuring probe that is identical to the third measuring probe;
the system includes a fourth data system associated with at least one static pressure port;
the fourth data system includes at least one static pressure port shared with the third data system;
the third data system includes the first electronic channel of the third measuring probe and the second electronic channel of the fourth measuring probe connected to each other, and the fourth data system includes the second electronic channel of the third measuring probe and the first electronic channel of the fourth measuring probe connected to each other;
the system includes two tertiary static pressure probes separated from the measuring probes and situated on either side of the aircraft, the static pressure ports of the fourth data system being situated on one and the other of the tertiary static pressure probes and being connected to each other;
the system includes two distinct primary sources for supplying electricity to the electronic devices of the measuring probes;
the channels of a given data system are powered at least by the same primary source;
each measuring probe includes a monitoring module connected to at least two other measuring probes and configured to provide status information on the operation of the measuring probe to which it belongs from the comparison between the estimates of the flight parameters provided by the data systems.

The invention also relates to an aircraft characterized in that it includes a system for estimating flight parameters according to the invention.

### BRIEF DESCRIPTION OF THE DRAWINGS

The invention will be better understood upon reading the following detailed description, provided solely as an example and done in reference to the appended Figures, in which:

FIG. 1 is a diagrammatic illustration of a system for providing flight parameters according to the invention onboard an aircraft according to the invention;

FIG. 2 is a diagrammatic illustration of the operation of the system of FIG. 1;

FIG. 3 is a diagrammatic illustration of a system for providing flight parameters according to another alternative of the invention;

FIG. 4 is a diagrammatic illustration of a system for providing flight parameters according to a further alternative of the invention;

FIG. 5 is a diagrammatic illustration of a system for providing flight parameters according to a yet further alternative of the invention;

FIG. 6 is a diagrammatic illustration of a system for providing flight parameters according to one particular example of the alternative of FIG. 5; and

FIG. 7 is a diagrammatic illustration of a system for providing flight parameters according to another particular example of the alternative FIG. 5.

### DETAILED DESCRIPTION

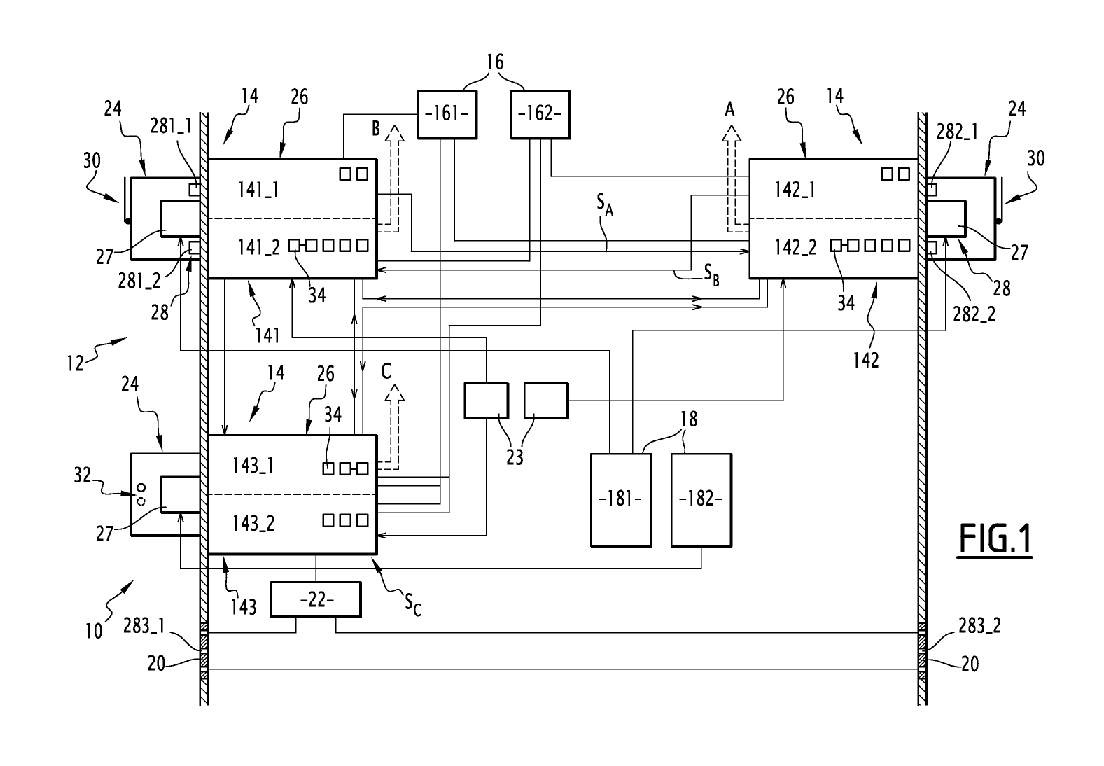

In reference to FIG. 1, the system for providing flight parameter estimates 10, hereafter the system 10, is intended to be placed onboard an aircraft 12 and is capable of providing an estimate of flight parameters according to three data channels A, B, C.

The flight parameters provided according to each of these data channels are the same.

The flight parameters whereof the estimates are provided by the system 10 include several elements from the group consisting of: the static pressure PS, the total pressure PT, the angle of attack AOA, the total air temperature TAT, the Mach number, the angle of side-slip AOS, the altitude ALT, the baro corrected altitude, the calibrated airspeed, the rate of climb Vz, the maximum operational speed VMO and Mach MMO (which depend on the altitude), and the true airspeed TAS.

The estimates provided by the system through each of the three data channels are independent from those of the other two data channels.

“Independent” means “operating or being determined from different static pressure information sources”.

The system 10 includes three multifunctional electronic measuring probes (hereafter MFE probes).

“Multifunctional probe” means that the probe is capable of providing information on at least two physical quantities correlated with the flight parameters, and more specifically on at least the total pressure and the angle of attack of the aircraft.

Furthermore, the system 10 includes two primary power supply sources 161, 162, hereafter primary sources 161, 162, as well as two secondary power supply sources 181, 182, hereafter secondary sources 181, 182. The system 10 also includes two static pressure probes 20, a flight data module 22 and two air temperature probes 23.

The three MFE probes include a first MFE probe 141, a second MFE probe 141 and a third MFE probe 143. All of the MFE probes are positioned at the skin of the aircraft 12.

The first MFE probe 141 is positioned on one of the sides of the aircraft 12, the second MFE probe 142 being positioned on the opposite side. In the example of FIG. 1, the first MFE probe 141 is on the port side. Furthermore, the third MFE probe 143 is also positioned on one of the sides of the aircraft, for example on the port side.

Each MFE probe includes an aerial portion 24 as well as an electronic device 26 connected to the aerial portion 24.

The first and second MFE probes 141, 142 are identical, i.e., their aerial portions 24 are identical to each other, and their electronic devices 26 are identical to each other. As a result, the part numbers of the two MFE probes 141, 142 are identical.

The third MFE probe 143 and the first and second MFE probes 141, 142 are dissimilar.

More specifically, the aerial portion 24 of the third MFE probe 143 is different from the aerial portions 24 of the first and second MFE probes 141, 142, and the electronic device 26 of the third MFE probe 143 is different from the electronic devices of the first and second MFE probes 141, 142.

“Different objects” refers to objects for which a common-mode breakdown is impossible, i.e., they cannot simultaneously breakdown for the same reason. This means that the essential elements—those involved in the chain of development of the parameters—of one of the objects, for example two MFE probes, are not present on the other object.

The aerial portion 24 of the MFE probes protrudes from the skin of the aircraft 12 such that it bathes in the flow around the aircraft 12 during its operation.

The aerial portion 24 of all of the MFE probes includes a heating device 27 connected to the corresponding electronic device 26 and capable of deicing the aerial portion 24 during operation of the aircraft 12.

The respective aerial portions 24 of the first and second MFE probes 141, 142 each include at least two static pressure ports (shown diagrammatically) bearing references 281-1, 281-2, 282-1, 282-2. The static pressure ports are positioned parallel to the body of the aircraft 12 on the corresponding aerial portion 24.

Furthermore, the aerial portion 24 of the first and second MFE probes 141, 142 includes at least one total pressure port positioned across from the flow (not shown), and mechanical means 30 for measuring the local angle of attack.

In the example of FIG. 1, the mechanical means 30 are made up of a rotating vane.

In practice, the aerial portions 24 of the first and second MFE probes 141, 142 assume the form of a rotating vane on which the orifices described above are positioned.

The aerial portion 24 of the third MFE probe 143 includes a total pressure port positioned across from the flow. Furthermore, it includes barometric means 32 for measuring the local angle of attack.

In the example of FIG. 1, the barometric means 32 are made up of two orifices, one of which is situated on the top of the aerial portion 24 parallel to the flow, and the other of which is situated on the bottom of the aerial portion 24 parallel to the flow.

In a known manner, the difference between the static pressures obtained by the two orifices makes it possible to deduce the local angle of attack of the aircraft 12.

The electronic devices 26 are capable of determining, from the information they receive from the different members to which they are connected, the estimates of the flight parameters that the system 10 provides via the different data channels A, B, C.

As illustrated in the Figures, each electronic device 26 is adjacent to the aerial portion 24 of the corresponding MFE probe. Each electronic device 26 is positioned at the foot of the associated aerial portion 24, on the side opposite the skin of the aircraft. This type of probe is known by the English acronym MFP, which stands for “multi-function probe”, or “electronic MFP”.

The electronic devices 26 are connected to an avionics system (not shown) onboard the aircraft 12, which provides information necessary to perform barometric corrections selected by the pilot, as well as a set of external data relative to the status of the moving members of the aircraft 12 (slats, flaps, landing gear, etc.), which may affect the estimates done.

The electronic devices 26 of the MFE probes each include a first electronic channel 141-1, 142-1, 143-1 and a second electronic channel 141-2, 142-2, 143-2.

Regarding the first and second probes 141, 142, the first channel 141-1 of the first MFE probe 141 is connected to the second channel 142-2 of the second MFE probe 142 to form a first data system S_{A} configured to provide the estimates of the flight parameters to the data channel A.

The second channel 141-2 of the first MFE probe 141 is connected to the first channel 142-1 of the second MFE probe 142 to form a second data system S_{B} configured to provide the estimates of the flight parameters to the data channel B.

The channels 141-1, 141-2, 142-1, 142-2 of the first and second MFE probes are respectively connected to one of the static pressure ports 28 of the corresponding aerial portion 24, a static pressure port being associated with a single channel. As a result, the estimates provided by the system 10 according to each of the three data channels A, B, C are independent from those of the other two data channels. Furthermore, this increases the availability of the system 4 due to the fact that at least one of the data channels A and B remains available if one of the static pressure ports 28 is blocked.

Furthermore, the second channel 141-2 of the first MFE probe 141 is connected to one of the temperature probes 23, and the second channel 142-2 of the second MFE probe 142 is connected to the other temperature probe 23.

The first channel 141-1, 142-1 of the first and second MFE probes 141, 142 includes a static pressure sensor capable of converting the information delivered by the corresponding static pressure port 281-1, 282-1 into a static pressure measurement PSAI for the channel 141-1 and PSBr for the channel 142-1, as well as a computation module configured to acquire the static pressure measurement PSAI, PSBr and control the communication of the channel with the second electronic channel 141-2, 142-2 to which it is connected.

The second channel 141-2, 142-2 of the first and second MFE probes 141, 142 includes a static pressure sensor capable of converting the information delivered by the corresponding static pressure port 281-2, 282-2 into a static pressure measurement PSBI for the channel 141-2 and PSAr for the channel 142-2, as well as a total pressure sensor capable of converting the information delivered by the total pressure orifice of its aerial portion 24 into a total pressure measurement PTB for the channel 141-2 and PTA for the channel 142-2.

The second channel 141-2, 142-2 of the first and second MFE probes 141, 142 further includes an angle of attack resolution module configured to convert the angle of attack information provided by the mechanical means 30 of the associated aerial portion 24 into an angle of attack measurement AOAB for the channel 141-2, and AOAA for the channel 142-2, as well as a processing module configured to process all of the data received by the channel 141-2, 142-2 and the total pressure, static pressure and angle of attack measurements that that channel performs, to determine the estimates of the flight parameters of the system S_{A}, S_{B}, respectively, and communicate them to the associated data channel A, B.

Furthermore, the second channel 141-2, 142-2 of the first and second MFE probes 141, 142 includes a heating module capable of controlling the heating device 27 and the corresponding aerial portion 24, and a monitoring module 34 connected to the other two MFE probes 14 and configured to determine status information of the corresponding data channel A, B.

Regarding the third MFE probe 143, the second channel 143-2 of the third MFE probe 143 is connected to the first channel 143-1 of that MFE probe 143 to form a third data system S_{C} configured to estimate the flight parameters via the data channel C.

Furthermore, the second channel 143-2 is connected to the flight data module 22 and the temperature probe 23, which is connected to the first probe 14.

The second channel 143-2 of the third MFE probe 143 includes a total pressure sensor and an angle of attack resolution module respectively configured to convert the information delivered by the associated aerial portion 24 into a total pressure measurement PTC and an angle of attack measurement AOAC.

Furthermore, the second channel 143-2 of the third MFE probe includes an acquisition module configured to centralize the PTC and AOAC measurements and the data received from the corresponding flight data module 22 and temperature probe 23, as well as to communicate them to the first channel 143-1 of the third MFE probe.

The first channel 143-1 of the third MFE probe 143 includes a heating module 37 for monitoring the heating device 27 of that probe, as well as a processing module capable of determining the estimates of the flight parameters from data transmitted by the second channel 143-2 and communicating them to the data channel C.

Furthermore, the first channel 143-1 of the third MFE probe 143 includes a monitoring module 34 connected to the other two probes MFE.

The primary sources are capable of supplying electricity to the electronic devices 26 of the system 10 so as to guarantee the availability of at least one of the data channels in case of failure of one of the primary sources.

To that end, a first primary source 161 is connected to the two channels 141-1, 142-2 of the data system S_{A}, as well as to the two channels 143-1, 143-2 of the third MFE probe 143.

The second primary source 162 is connected to the two channels 142-1, 141-2 of the data system B, as well as to the two channels 143-1, 143-2 of the third MFE probe.

Thus, in case of failure of one of the primary sources 161, 162, two data channels remain available.

The secondary sources 181, 182 are capable of supplying electricity to the heating devices 27 so as to guarantee the availability of at least one heating device 27 in case of breakdown of one of the secondary sources 181, 182.

To that end, a first secondary source 181 is connected to the heating systems 27 of the first and second MFE probes 141, 142, and the second secondary source 182 is connected to the heating device 27 of the third MFE probe 142.

The static pressure probes 20 and the flight data module 22 are capable of providing the second channel 143-2 of the third MFE probe 143 with static pressure information compensated to account for the side-slip of the aircraft.

The static pressure probes 20 are situated at the skin of the aircraft 12 on either side thereof. They are positioned parallel to the cockpit of the aircraft.

The static pressure probes 20 each include at least one static pressure port 283-1, 283-2, respectively, associated with the third probe and pneumatically connected to each other.

In a known manner, the angle of side-slip is formed by the axis of the fuselage of the aircraft and the trajectory of the aircraft. A non-zero side-slip amounts to a non-zero contribution of the dynamic pressure to the measured pressure for the ports oriented toward the upstream direction of flow, and conversely a lower experienced pressure for the ports oriented toward the downstream direction of the flow.

In order to compensate for this phenomenon, the pressure ports situated on either side of the aircraft are connected to each other pneumatically so as to provide the flight data module 22 with static pressure information averaged from the information respectively provided by the two probes 20.

Alternatively, each static pressure probe 20 is associated with a local measuring sensor converting the static pressure information provided by the corresponding probe into a digital or analog static pressure measurement. The sensors are then both connected to the output of the flight data module 22, which performs the compensation for the side-slip from digital or analog information.

This alternative is advantageously implemented when a pneumatic connection between the static pressure ports poses integration problems.

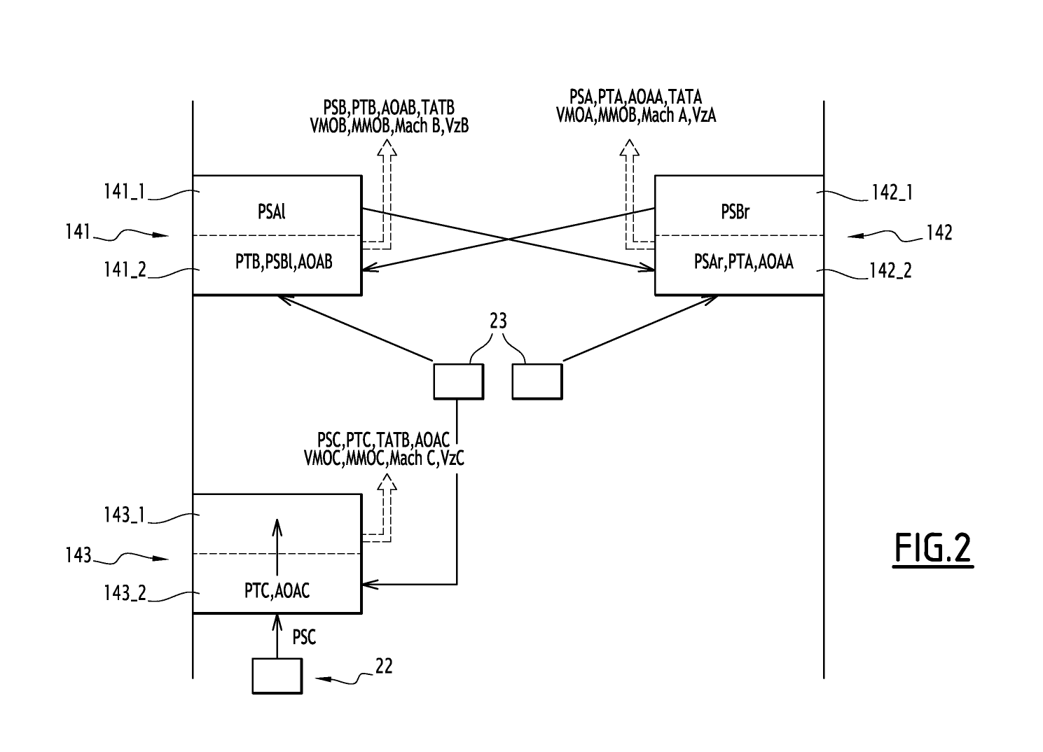

The operation of the system 10 will now be described in reference to FIGS. 1 and 2.

During the operation of the system 10, the primary sources 161, 162 supply electricity to the channels of the electronic devices 26.

The first channels 141-1, 142-1 of the first and second MFE probes 141, 142 determine a measurement of the static pressure PSAI, PSBr from information provided by the corresponding static pressure port 281-1, 282-1.

These measurements are provided to the second channel 141-2, 142-2 of the corresponding data system S_{A}, S_{B}.

The second channel 141-2, 142-2 in question also determines a static pressure measurement PSBI, PSAr from information supplied by the associated static pressure port 281-2, 282-2, a measurement of the angle of attack AOAA, AOAB from information provided by the corresponding mechanical means 30, and a total pressure measurement PTA, PTB from information provided by the total pressure port of the corresponding aerial portion 24.

The second channel 141-2, 142-2 determines estimates of the flight parameters from:
measurements of the angle of attack AOA, AOB, the static pressure PSBI, PSAr, and the total pressure PTA, PTB that it has determined itself,
static pressure measurements PSAI, PSBr provided by the first channel 141-1, 142-1 of its data system A, B, and
total air temperature measurements TATA, TATB provided by the associated temperature probe 23.

These estimates are then provided to the corresponding data channel A, B.

The second channel 143-2 of the third MFE probe 143 in turn determines a measurement of the total pressure PTC and a measurement of the angle of attack AOAC from information respectively provided by the total pressure port and the barometric means 32 of the third MFE probe 143, and collects the measurement of the static pressure PSC provided by the data module 22.

All of this data is then provided to the first channel 143-1.

The first channel 143-1 then estimates the flight parameters from:
measurements of the total pressure PTC, angle of attack AOAC, and static pressure PSC provided by the second channel 143-2, and
the measurement of the total temperature TATB provided by the associated temperature probe 23.

These estimates are then sent by the system 10 via the data channel C.

The data systems S_{A}, S_{B}, S_{C} then provide an estimate of the same flight parameters.

Furthermore, the monitoring modules 34 determine status information of the data channel with which they are respectively associated by comparing the estimates of the flight parameters determined by the electronic channel in which they are located with the estimates determined by the other channels.

To that end, each monitoring modules 34 compares the estimates of the flight parameters done by its electronic channel with the estimates associated with the other channels.

For example, if the deviation between the estimates associated with its data channel A, B, C and the estimates provided by the other data channels is above a threshold value for a predetermined number of flight parameters, then it uses the corresponding data channel to send status information indicating that the estimates provided by its data channel may be erroneous.

Furthermore, each electronic device 26 controls the corresponding heating device 27 so as to prevent and/or resolve any icing problem occurring on the corresponding aerial portions 24.

The system 10 according the invention makes it possible to provide estimates of flight parameters according to three data channels A, B, C that are independent of each other, from three MFE probes, two of which are identical.

In fact, the or each static pressure port of the first data system S_{A}, the second data system S_{B} and the third data system S_{C} is separate from the or each static pressure port of the others from among the first data system, the second data system and the third data system.

As a result, the system has three independent data channels while facilitating management of the related inventory, since the three MFE probes are only associated with two part numbers.

Furthermore, due to the presence of the monitoring modules 34, the data provided by the system 10 is consolidated.

Lastly, the operating safety and security functions are met by the system 10.

Several alternatives of the example described above may be considered.

In a first alternative (not shown), the third MFE probe 143 is positioned at a location on the aircraft near which the pressure field is not affected by the side-slip of the aircraft. Such locations depend on the aerodynamics of the aircraft and are known by those skilled in the art.

In this alternative, the static pressure ports 283-1, 283-2 associated with the third probe 143 and the third data system S_{C} are situated on the aerial portion 24 of the third MFE probe 143.

The second channel 143-2 then includes a pressure sensor capable of determining a static pressure measurement from information provided by the static pressure ports 283-1, 283-2.

Furthermore, the system 10 does not include static pressure probes 20, or data modules 22. The other members of the system 10 are those described in reference to FIG. 1.

It should be noted that in this alternative, only one static pressure port 283-1, 283-2 is sufficient to ensure proper operation of the third data system S_{C}.

During the operation of the system 10 according to this alternative, the first channel 143-1 of the third probe 143 uses the measurement of the static pressure done by the second channel 143-2 instead of the measurement provided by the data module 22 to determine the estimates of the flight parameters.

This alternative is advantageously implemented in order to limit the number of members included by the system.

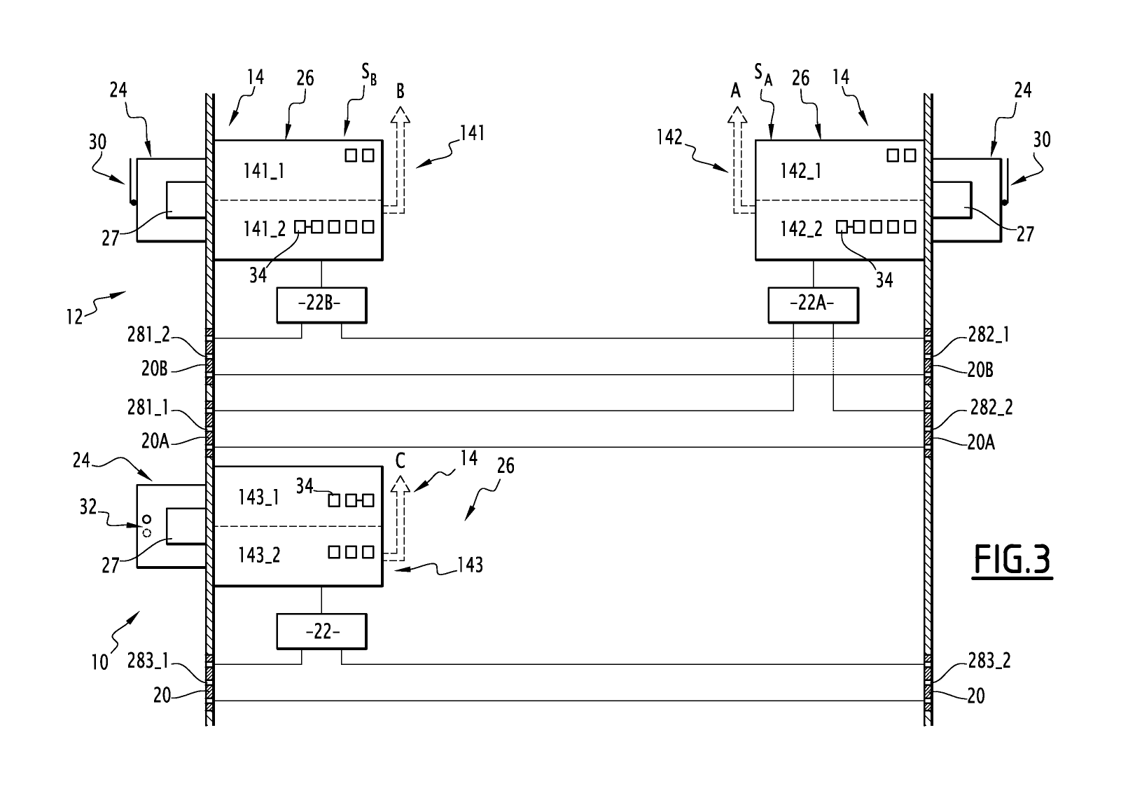

In reference to FIG. 3, in a second alternative, the first data system S_{A} is formed by the channels 142-1, 142-2 of the second probe 142 that are connected to each other.

The second data system S_{B} is formed by the channels 141-1, 141-2 of the first probe 141 that are connected to each other.

Furthermore, the static pressure ports 281-1, 281-2, 282-1, 282-2 associated with the first and second probes 141, 142 are not situated on the corresponding aerial portions 24.

However, the system 10 includes primary static pressure probes 20A separated from the aerial portions 24 and situated on either side of the aircraft. The static pressure ports 281-1, 282-2, which in the example of FIG. 1 were associated with the data system S_{A} and were placed on the aerial portions 24 of the first, second MFE probes, respectively, are situated on one and the other of the primary static pressure probes 20A, respectively, and are connected to each other pneumatically. Furthermore, the system 10 includes a primary flight data module 22A connected to the primary static pressure probes 20A and the second channel 142-2 of the second MFE probe 142.

Likewise, the system 10 includes secondary static pressure probes 20B separated from the aerial portions 24 of the MFE probes and situated on either side of the aircraft. The static pressure ports 281-2, 282-1, which in the example of FIG. 1 were associated with the data system S_{B} and were placed on the aerial portions 24 of the first, second MFE probes, respectively, are situated on one and the other of the secondary static pressure probes 20B, respectively, and are connected to each other pneumatically.

Furthermore, the system includes a secondary flight data module 22B connected to the static pressure ports 20B and the second channel 141-2 of the first MFE probe 141.

Furthermore, the first channel of the first and second MFE probes 141, 142 is not connected to the second channel of the second, first MFE probes, respectively.

As will have been understood, in this alternative, the first and second MFE probes 141, 142 receive static pressure information in a manner similar to the manner in which the third MFE probe 143 obtains the static pressure information in the example described above.

During the operation of the system 10 according to this alternative, the static pressure probes 20B provide the data module 22B with static pressure information averaged to compensate for the side-slip of the aircraft. The module 22B determines a measurement of the static pressure from that information, and communicates it to the second channel 141-2 of the first probe, which then uses that measurement to estimate the flight parameters.

The data module 22A also measures the static pressure from information provided by the static pressure probes 20A, and communicates its measurement to the second channel 142-2, which estimates the flight parameters from that measurement, inter alia.

This alternative is advantageously implemented so as to avoid the loss of two data channels in case of icing of the aerial portion 24 of one of the two first MFE probes.

It should be noted that in this alternative, the determination of the total pressure and/or angle of attack measurements, which, in the example of FIG. 1, occur in the second channels 141-2, 142-2 of the first and second probes 141, 142, may be done in the first channels 141-1, 142-1, which then communicate their measurement to the second corresponding channel.

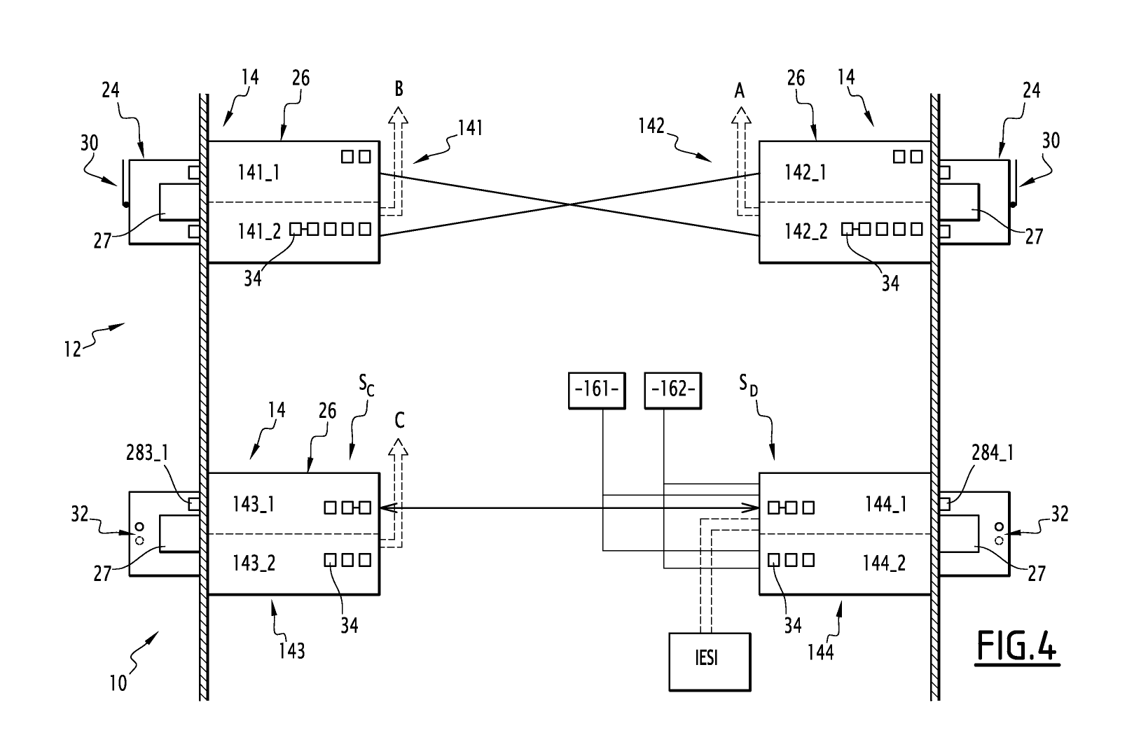

In reference to FIG. 4, in a third alternative, the system 10 includes a fourth MFE probe 144 identical to the third probe 143 and positioned on the opposite side of the aircraft. The fourth MFE probe 144 is connected to the temperature probe 23, which is connected to the second MFE probe 142.

Furthermore, the system 10 does not include static pressure probes 20 or an associated data module 22.

The aerial portion 24 of the third MFE probe 143 includes at least one static pressure port 283-1, the aerial portion of the fourth MFE 144 including at least one reference static pressure port 284-1.

The electronic channels 144-1, 144-2 of the fourth probe 144 are connected to each other and form a fourth data system S_{D} configured to provide an estimate of the flight parameters to integrate electronic backup equipment, also referred to as Integrated Electronic Standby Instrument (IESI), capable of providing flight information to the pilot if needed.

The first channels 143-1, 144-1 of the third and fourth MFE probes 143, 144 are connected to each other.

The static pressure ports 283-1, 284-1 are shared by the third and fourth data systems S_{C}, S_{D}.

The channels of the fourth MFE probe 144 are both connected to the two primary sources 161, 162.

The other members of the system 10 are those described in reference to FIG. 1.

During the operation of the system according to this alternative, the first channels of the third and fourth MFE probes 143, 144 perform a measurement of the static pressure from information provided by the static pressure port 283-1, 284-1 situated on the corresponding aerial portion 24, and exchange the static pressure measurements they take with each other.

Each of these channels thus has static pressure measurements from which they compensate for the side-slip of the aircraft.

It should be noted that in this alternative, the estimates provided by the system 10 via the data channel C and the estimates provided to the IESI are not independent, even if they are a priori different.

This alternative is advantageously implemented so as to benefit from an additional source of flight data estimates while minimizing the number of members and part numbers included by the system.

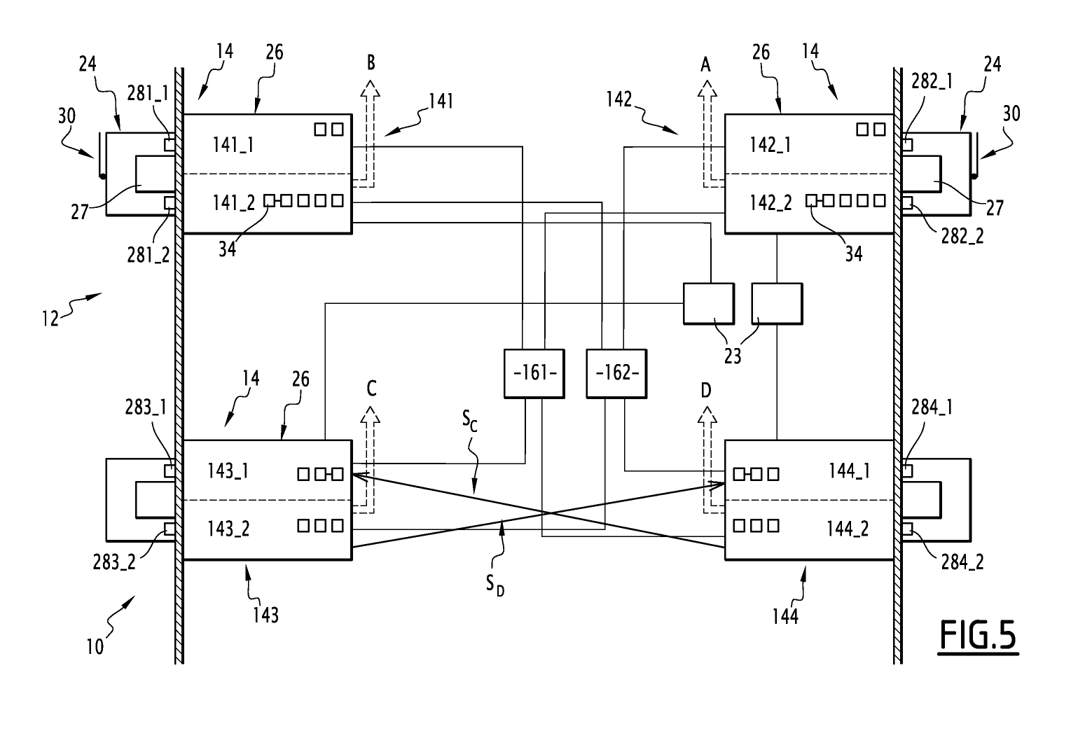

In reference to FIG. 5, in a fourth alternative, the system 10 includes four independent data channels A, B, C, D.

To that end, the system 10 does not include the static pressure ports 20 or the flight data module 22.

However, the aerial portion 24 of the third MFE probe 143 includes at least one static pressure port 283-1 connected to the first channel 143-1 of the probe 143, and at least one static pressure port 283-2 connected to the second channel 143-2 of the probe 143.

Furthermore, the system 10 includes a fourth MFE probe 144 identical to the third MFE probe 143. The fourth probe 144 is connected to the temperature probe 23, which is connected to the second MFE probe 142.

The first channel 143-1 of the third MFE probe 143 is connected to the second channel 144-2 of the fourth MFE probe 144 to form the third data system S_{C} configured to provide an estimate of the flight parameters according to the third data channel C.

The second channel 143-2 of the third MFE probe 143 is connected to the first channel 144-1 of the fourth probe to form a fourth data system S_{D} configured to provide an estimate of the flight parameters according to a fourth data channel D.

In the same way as in the system of FIG. 1, the data systems S_{C} and S_{D} are independent in terms of their electrical power supply.

To that end, the channels 143-1, 144-2 of the third data system S_{C} are connected to the same primary source 161, 162, for example the first primary source 161, while the channels 143-2, 144-1 of the fourth data system S_{D} are connected to the other primary source, for example the second primary source 162.

The other members of the system 10 are those described in reference to FIG. 1.

During the operation of the system 10 according to this alternative, each channel 143-1, 143-2, 144-1, 144-2 of the third and fourth MFE probes 143, 144 determines a static pressure measurement from information delivered by the static pressure orifice(s) 283-1, 283-2, 284-1, 284-2 to which it is connected.

The second channels 143-2, 144-2 of the third and fourth MFE probes 143, 144 communicate their measurement of the static pressure to the first channel 143-1, 144-1 of the other MFE probe 143, 144, such that the first channels 143-1, 144-1 have static pressure measurements from which the side-slip of the aircraft can be compensated.

It should be noted that the static pressure measurement done by each of the second channels 143-2, 144-2 of the third and fourth MFE probes 143, 144 is not communicated to the first channel 143-1, 144-1 of the same MFE probe 143, 144 so as to guarantee the independence of the estimates provided according to each of the data channels A, B, C, D.

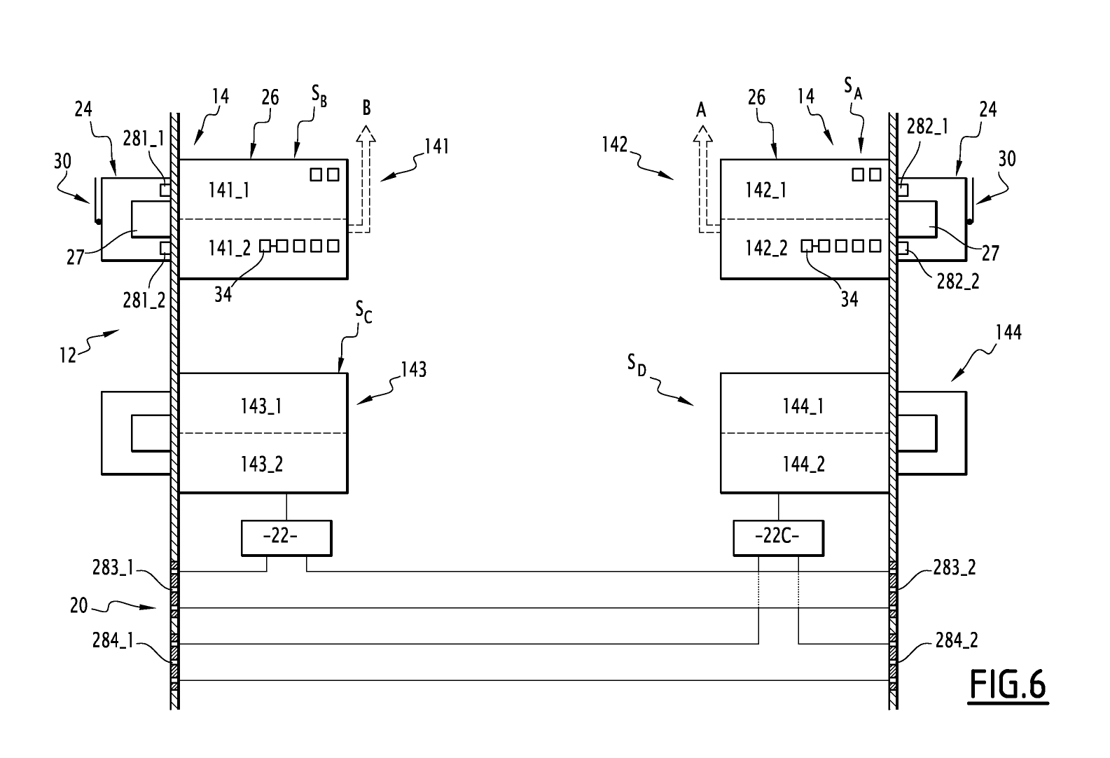

In reference to FIG. 6, in another example of this fourth alternative, the system 10 includes the static pressure probes 20 previously described and on which the static pressure ports 283-1, 283-2 are situated, as well as the associated flight data module 22.

Furthermore, the system 10 includes static pressure probes associated with the fourth MFE probe 144, hereafter tertiary static pressure probes 20C, on which the static pressure ports 284-1, 284-1 are situated, as well as an associated tertiary flight data module 22C.

The third data system S_{C} is formed by the two channels 143-1, 143-2 of the third MFE probe 143, which are connected to each other.

The fourth data system S_{D} is formed by the two channels 144-1, 144-2 of the fourth probe 144, which are connected to each other.

The third and fourth data systems S_{C}, S_{D} perform the estimates of the flight parameters from the static pressure information provided by the corresponding static pressure probes and flight data module.

This example makes it possible, as previously indicated, to avoid the loss of data channels in case of icing of the aerial portions 24 of the third and fourth MFE probes.

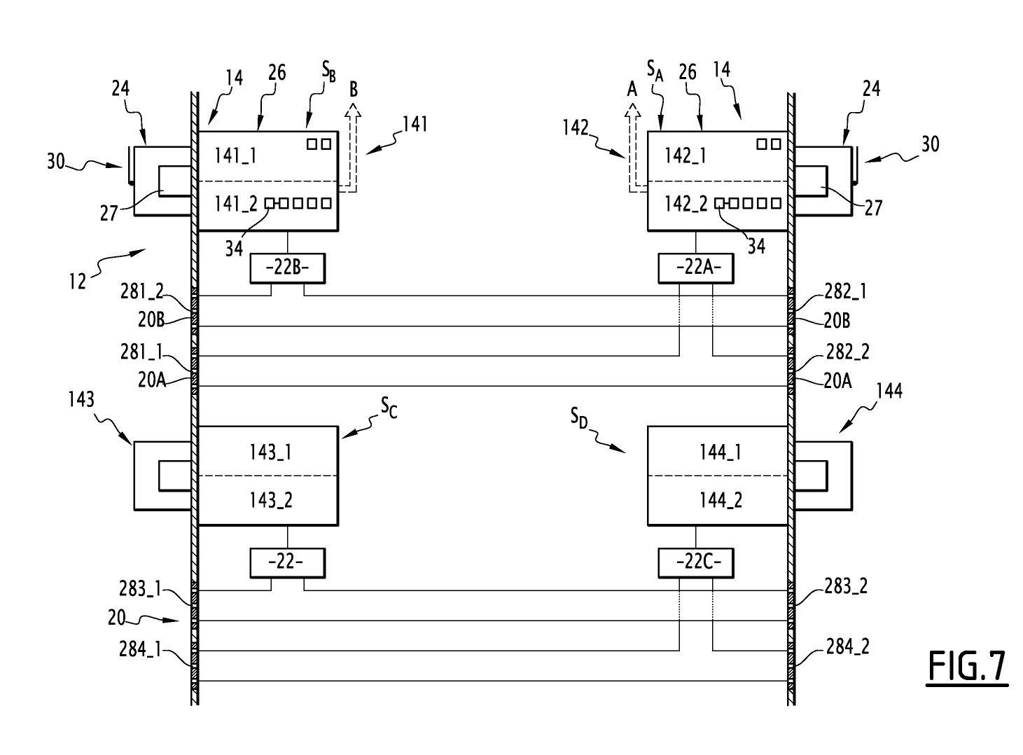

In reference to FIG. 7, in another example of this alternative, the example of FIG. 3 and the example previously described are combined, i.e., each MFE probe 141, 142, 143, 144 is associated with static pressure probes positioned on either side of the aircraft and on which the static pressure ports are situated, as well as a flight data module connected to the static pressure probes and an electronic channel of the considered MFE probe.

During the operation of the system 10 according to this example, each MFE probe thus directly determines a static pressure measurement taking the side-slip of the aircraft into account, as previously described.

In other examples, the pneumatic connection of the static pressure probes to each other is replaced by an electrical connection, the probes being coupled to a local data module converting the static pressure information into digital or analog information representative of the associated static pressure. Compensation for the side-slip is then done from digital or analog information directly on the channels, as previously described.

In alternatives of the described examples, one or more flight data 22, 22A, 22B, 22C that the system 10 may include are internal to the device of the corresponding MFE probe.

1. A system for estimating flight parameters of an aircraft, comprising
a plurality of static pressure ports;
a plurality of measuring probes, each measuring probe comprising an aerial portion capable of providing at least one physical quantity correlated to the flight parameters and different from the static pressure, an electronic device configured to estimate the flight parameters from the physical quantities, and at least one static pressure measurement;
wherein:
a first measuring probe and a second measuring probe have identical aerial portions and identical electronic devices;
a third measuring probe has an aerial portion and an electronic device that are different from those of the first measuring probe and the second measuring probe;
the electronic devices of the first measuring probe, the second measuring probe and the third measuring probe, and the static pressure ports are connected so as to form a first data system, a second data system and a third data system respectively associated with at least one static pressure port and each providing a respective estimate of the same flight parameters,
the or each static pressure port of each of the first data system, the second data system and the third data system is different from the or each static pressure port of the others among the first data system, the second data system and the third data system.

2. The system according to claim 1, wherein the electronic device of each measuring probe comprises a first electronic channel and a second electronic channel, each of the first data system, the second data system and the third data system comprising a first channel of a measuring probe and a second channel of a measuring probe connected to each other.

3. The system according to claim 2, wherein the first data system comprises the first channel of the first measuring probe and the second channel of the second measuring probe connected to each other, and the second data system comprises the second channel of the first measuring probe and the first channel of the second measuring probe connected to each other.

4. The system according to claim 3, wherein the first data system comprises a static pressure port on the aerial portion of the first measuring probe and a static pressure port positioned on the aerial portion of the second measuring probe, and wherein the second data system comprises a static pressure port positioned on the aerial portion of the second measuring probe and a static pressure port positioned on the aerial portion of the first measuring probe.

5. The system according to claim 2, wherein the first data system comprises the first channel of the first measuring probe and the second channel of the first measuring probe, and wherein the second data system comprises the first channel of the second measuring probe and the second channel of the second measuring probe.

6. The system according to claim 5, comprising two primary static pressure probes separated from the measuring probes and situated on either side of the aircraft, the static pressure ports of the first data system being situated on one and the other of said primary static pressure probes and being connected to each other.

7. The system according to claim 5, further comprising two secondary static pressure probes separate from the measuring probes and situated on either side of the aircraft, the static pressure probes of the second data system being situated on one and the other of said secondary static pressure probes and being connected to each other.

8. The system according to claim 1, comprising two static pressure probes separated from the measuring probes and situated on either side of the aircraft, the static pressure probes of the third data system being situated on said static pressure probes and being connected to each other.

9. The system according to claim 2, wherein the third data system comprises the first channel and the second channel of the third measuring probe.

10. The system according to claim 2, further comprising a fourth measuring probe that is identical to the third measuring probe.

11. The system according to claim 10, comprising a fourth data system associated with at least one static pressure port.

12. The system according to claim 11, wherein the fourth data system comprises at least one static pressure port shared with the third data system.

13. The system according to claim 10, wherein:
the third data system comprises the first channel of the third measuring probe and the second channel of the fourth measuring probe connected to each other; and
the fourth data system comprises the second channel of the third measuring probe and the first channel of the fourth measuring probe connected to each other.

14. The system according to claim 8, comprising two tertiary static pressure probes separated from the measuring probes and situated on either side of the aircraft, the static pressure ports of the fourth data system being situated on one and the other of the tertiary static pressure probes and being connected to each other.

15. The system according to claim 1, wherein it comprises two distinct primary sources for supplying electricity to the electronic devices of the measuring probes.

16. The system according to claim 2, wherein the channels of a given data system are powered at least by the same primary source.

17. The system according to claim 1, wherein each measuring probe comprises a monitoring module connected to at least two other measuring probes and configured to provide status information on the operation of the measuring probe to which it belongs from the comparison between the estimates of the flight parameters provided by the data systems.

18. An aircraft, wherein it comprises a system for estimating flight parameters according to claim 1.
